(19) United States
(12) Patent Application Publication
(10) Pub. No.: US 2003/0103726 A1
(43) Pub. Date: Jun. 5, 2003

(54) Optical device

(76) Inventors: Kenji Mori, Osaka-shi (JP); Toshiaki Anzaki, Osaka-shi (JP); Terufusa Kunisada, Osaka-shi (JP); Masahiro Oikawa, Osaka-shi (JP)

Correspondence Address: Y. ROCKY TSAO, Fish & Richardson P.C., 225 Franklin Street, Boston, MA, 02110-2804, US

(21) Appl. No.: 10/273,743

(22) Filed: Oct. 18, 2002

(30) Foreign Application Priority Data
Oct. 18, 2001 (JP) 2001-321231
Apr. 22, 2002 (JP) 2002-119894

(51) Int. Cl. G02B 6/32; G02B 6/26

(52) U.S. Cl. 385/34; 385/31; 385/15

(57) ABSTRACT

The optical device, capable of reducing reflectance over a wide wavelength region, has an anti-reflection film interposed between a rod lens and an optical fiber. The anti-reflection film includes a plurality of laminas. The refractive index of the lamina contiguous to the optical fiber is matched with that of the optical fiber, while the refractive index of the lamina contiguous to the rod lens is matched with that of the rod lens. The laminas are set to have refractive indices such that the refractive index of the optical fiber and that of the rod lens are connected to each other to form a smooth curve.

### BACKGROUND OF THE INVENTION

The present invention relates to an optical device having two optical elements with different refractive indices respectively, more specifically to an optical device, in which light is introduced from one optical element into the other optical element.

In a conventional optical device, two optical elements are bonded to each other with an adhesive as described below. Japanese Unexamined Patent Publication No. Hei 2-27301 discloses an optical device incorporated herein as a first prior art example. In the first prior art example, two prisms each have an anti-reflection film formed on a surface thereof, and these anti-reflection films are bonded to each other with an adhesive. The anti-reflection films are designed to have as a refractive index which is an intermediate value of the refractive index of the prisms and that of the adhesive.

Japanese Unexamined Patent Publication No. Hei 7-225301 discloses an optical device incorporated herein as a second prior art example. In the second prior art example, a first glass material has a double-layer anti-reflection film formed thereon and the film is bonded to a second glass material with an adhesive. An adhesive having the refractive index different from that of the second glass material by 0.1 or less is used for the bonding.

Japanese Unexamined Patent Publication No. Hei 7-225301 discloses an optical device incorporated herein as a third prior art example. In the third prior art example, a double-layer anti-reflection film formed on a first glass material is bonded to a double-layer anti-reflection film formed on a second glass material with an adhesive.

There is known an optical device, incorporated herein as a fourth prior art example, in which an anti-reflection film formed on an end face of a gradient index rod lens is bonded to an optical fiber with an adhesive having a refractive index approximate to that of the optical fiber.

There is also known an optical device, incorporated herein as a fifth prior art example, having a single optical layer interposed between a gradient index rod lens and an optical fiber or between a rod lens and an adhesive and has a refractive index which is an intermediate value of the refractive index of the rod lens and that of the optical fiber.

However, these prior art examples involve the following problems.

(1) In the optical device of the first prior art example, since the refractive index of the anti-reflection film is an intermediate value of the refractive index of the prism and that of the adhesive, gaps (difference) are present between the refractive index of the anti-reflection film and that of the adhesive, as well as, between the refractive index of the anti-reflection film and that of the prism. Thus, reflection at the interface between the anti-reflection film and the adhesive, as well as, the reflection at the interface between the anti-reflection film and the prism cannot be reduced fully, resulting in insufficient reflection preventing performance.

(2) In the optical devices as disclosed in the second and third prior art examples, the anti-reflection films containing about 2 to 4 layers have narrow anti-reflection wavelength regions and permit a great amount of reflection of light of wavelengths which are not included within the designed wavelength region. Meanwhile, in the optical device of the fifth prior art example, reflection of light having wavelengths around the designed region can be prevented, but the farther it is away from the designed wavelength region, the poorer becomes the reflection property as the optical device has a narrow anti-reflection wavelength region.

(3) In the optical device of the fourth prior art example, the refractive index of the rod lens is higher than that of the optical fiber and that of the adhesive. The mismatching in refractive index causes losses at the interface between the adhesive and the anti-reflection film, i.e., the interface between the optical fiber and the rod lens, failing to achieve sufficient reduction of reflection at the interface. Thus, a countermeasure should be taken for preventing the light reflected at the interface between the optical fiber and the anti-reflection film from returning to the light source side. Working of the optical device for this purpose complicates production process of the optical device.

(4) In any of the prior art examples, the refractive index of the anti-reflection film was determined by its material to be selected. Therefore, it is difficult to set the refractive index of the anti-reflection film at a desired value.

### SUMMARY OF THE INVENTION

It is an objective of the present invention to provide an optical device, which can reduce reflection at an interface at a high-level, reduce refractive index of light over a wide wavelength region and dispense with a countermeasure for preventing back reflection, and which can select unreservedly the refractive index of the anti-reflection film when it is to be formed.

To achieve the above objective, the present invention provides an optical device in which light is introduced from a first optical element having a first refractive index and a second optical element having a second refractive index which differs from the first refractive index. The optical device includes an anti-reflection film interposed between the first optical element and the second optical element. The anti-reflection film has a first interface opposing the first optical element and a second interface opposing the second optical element. The first interface has a refractive index substantially equal to that of the first refractive index, the second interface has a refractive index substantially equal to that of the second refractive index. The refractive index of the anti-reflection film continuously changes between the first interface and the second interface.

A further perspective of the present invention is an optical device in which light is introduced from a first optical element having a first refractive index into a second optical element having a second refractive index which differs from the first refractive index. The optical device includes an anti-reflection film interposed between the first optical element and the second optical element. The anti-reflection film has a plurality of laminas including a first lamina opposing the first optical element and a second lamina opposing the second optical element. The first lamina has a refractive index substantially equal to that of the first refractive index, the second lamina has a refractive index substantially equal to that of the second refractive index. The refractive index of the anti-reflection film changes monotonously between the first lamina and the second lamina.

Other aspects and advantages of the present invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a schematic view showing an optical fiber collimator according to a first embodiment of the present invention;

FIG. 2 is a partly enlarged view of FIG. 1;

FIG. 3 is a graph showing a refractive index distribution of an anti-reflection film according to the first embodiment;

FIGS. 4A to 4E are graphs showing refractive index distributions of anti-reflection films according to the first embodiment;

FIGS. 5A to 5E are graphs showing reflection characteristics of the anti-reflection films shown in FIGS. 4A to 4E, respectively;

FIGS. 6A to 6E are graphs showing refractive index distributions of anti-reflection films according to a second embodiment of the present invention;

FIGS. 7A to 7E are graphs showing reflection characteristics of the anti-reflection films shown in FIGS. 6A to 6E, respectively;

FIGS. 8A to 8E are graphs showing refractive index distributions of anti-reflection films according to a third embodiment of the present invention;

FIGS. 9A to 9E are graphs showing reflection characteristics of the anti-reflection films shown in FIGS. 8A to 8E, respectively;

FIG. 10A is a graph showing a refractive index distribution of an anti-reflection film of Example 1;

FIG. 10B is a graph showing reflection characteristics of the anti-reflection film of Example 1;

FIG. 11A is a graph showing a refractive index distribution of an anti-reflection film of Example 2;

FIG. 11B is a graph showing reflection characteristics of the anti-reflection film of Example 2;

FIG. 12A is a graph showing a refractive index distribution of an anti-reflection film of Example 3;

FIG. 12B is a graph showing reflection characteristics of the anti-reflection film of Example 3;

FIG. 13A is a graph showing a refractive index distribution of an anti-reflection film of Example 4;

FIG. 13B is a graph showing reflection characteristics of the anti-reflection film of Example 4;

FIG. 14A is a graph showing a refractive index distribution of an anti-reflection film of Comparative Example; and

FIG. 14B is a graph showing reflection characteristics of the anti-reflection film of Comparative Example.

### DETAILED DESCRIPTION OF THE PREFERRED EMBODIMENTS

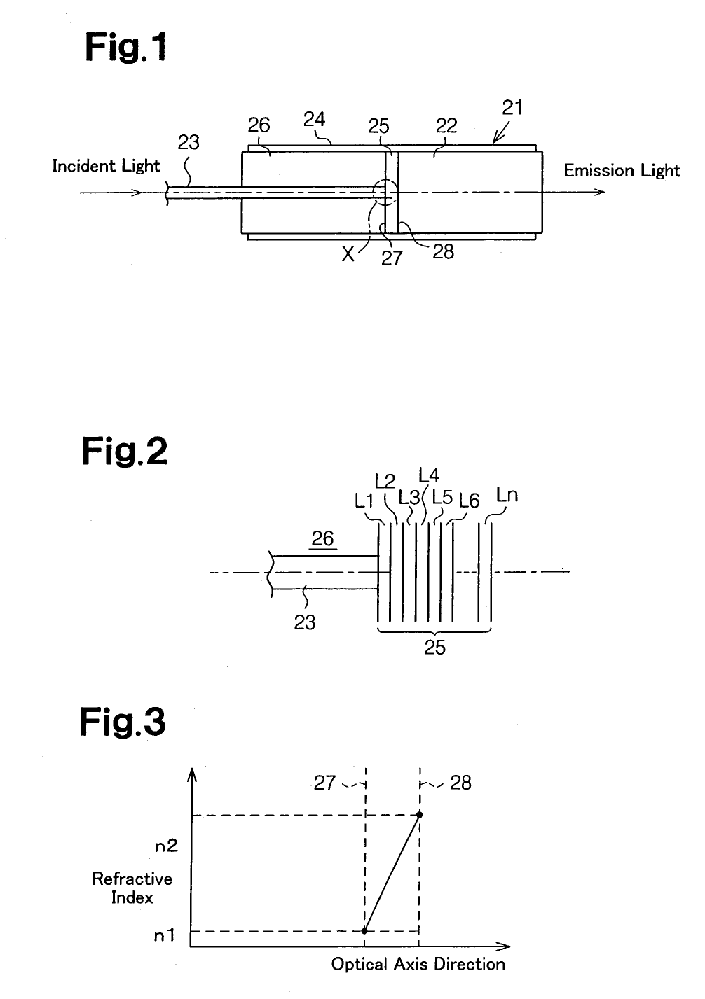

An optical device or optical fiber collimator 21 according to a first embodiment of the present invention will be described below. As shown in FIG. 1, the optical fiber collimator 21 includes a glass tube 24, an optical element contained in the glass tube 24, i.e., a gradient index type rod lens 22, and another optical element connected to the rod lens 22, i.e., a single mode optical fiber 23.

An anti-reflection film 25 is formed on the left end face of the rod lens 22. The optical fiber 23 is inserted into an inserting hole defined in a glass capillary 26. The right end face of the optical fiber 23 is polished to be perpendicular to the optical axis of the optical fiber 23. The right end face of the optical fiber 23 and the capillary 26 are bonded to the anti-reflection film 25 through an ultraviolet curing optical adhesive (not shown). The adhesive is cured by ultraviolet irradiation to fix the anti-reflection film 25 to the optical fiber 23 and the capillary 26.

A collimator optical apparatus is composed of a pair of optical fiber collimators 21. In the collimator optical apparatus, the light coming out from the entrance side optical fiber 23 is converted into parallel light by the entrance side rod lens 22. The parallel light is converged by the acceptor side rod lens 22 and is colligated to the receptor side optical fiber 23. An optical function device (e.g., an optical filter, an optical isolator, an optical switch and an optical modulator) is interposed between these two rod lenses 22. The optical function device exerts a predetermined action upon the light transmitted through the entrance side optical fiber 23. The resulting light is transmitted to the receptor side optical fiber.

FIG. 2 is a partly enlarged view of the circled section X in FIG. 1, showing the right end portion of the optical fiber 23 and the anti-reflection film 25. The anti-reflection film 25 is a multi-layer film formed by laminating n layers of laminas (L1, L2, L3 . . . Ln). The refractive index of a first lamina L1 forming the interface 27 between the anti-reflection film 25 and the optical fiber 23 is substantially equal to the refractive index n1 of the optical fiber. The refractive index of a second lamina Ln forming the interface 28 between the anti-reflection film 25 and the rod lens 22 is substantially equal to the refractive index n2 of the rod lens 22. The refractive indices of one or more third films formed between the lamina L1 and the lamina Ln (L2 to Ln-1) are selected such that they change gradually from the refractive index n1 of the optical fiber 23 to the refractive index n2 of the rod lens.

If the anti-reflection film 25 has a sufficiently large number of layers n, the refractive index of the anti-reflection film 25 changes continuously, as shown in FIG. 3. In the first embodiment, the refractive index distribution of the anti-reflection film 25 can be expressed by a function which increases monotonously from a value substantially equal to the refractive index n1 of the optical fiber 23 to that substantially equal to the refractive index n2 of the rod lens 22, particularly by a linear expression that changes linearly. In other words, the anti-reflection film 25 is a gradient index film changing between n1 and n2.

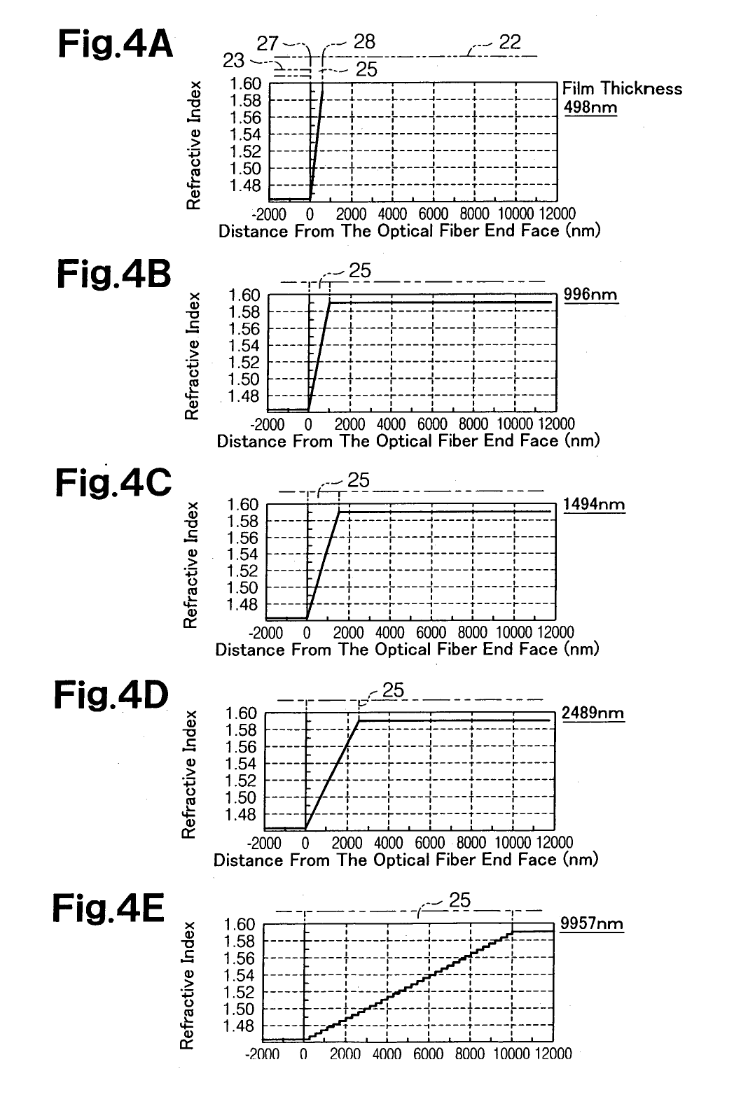

FIGS. 4A to 4E are graphs showing changes in refractive index (index distribution) of anti-reflection films 25 along the optical axes thereof respectively, wherein the thickness of the anti-reflection film 25 (i.e., the distance from the end face of the optical fiber 23 serving as an entrance side medium) is taken on the axis of abscissa, and the refractive index is taken on the axis of ordinate.

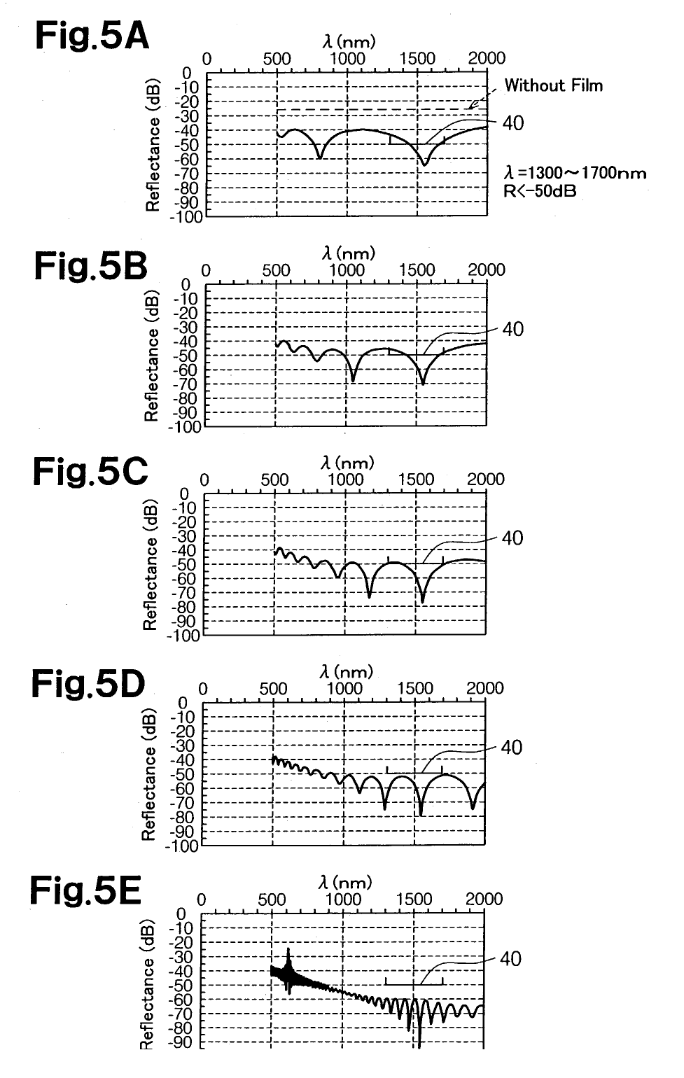

FIGS. 5A to 5E are graphs showing reflection characteristics of the anti-reflection films 25 shown in FIGS. 4A to 4E, respectively, wherein wavelength is taken on the axis of abscissa, and the reflectance is taken on the axis of ordinate. The reflectance (dB) was determined by measuring back reflection from the interface 27 between the anti-reflection film 25 and the optical fiber 23, as is described later. In the field of optical communication, the reflectance of −45 to −55 db or less is required over the wavelength region of 1300 to 1700 nm. Thus, the median of the reflectance −50 dB was set as a reference reflectance level, and reference marks 40 are indicated in FIGS. 5A to 5E so as to show the reflectance level and the wavelength region. The broken line in FIG. 5A shows the reflectance measured in the absence of the anti-reflection film 25.

The anti-reflection films 25 shown in FIGS. 4A to 4E were each formed by laminating 49 layers of laminas. The anti-reflection film 25 of FIG. 4A has a film thickness of 498 nm. Here, the thickness of each lamina corresponds to 0.01 times the wavelength 1550 nm. The anti-reflection film 25 of FIG. 4B has a film thickness of 996 nm. Here, the thickness of each lamina corresponds to 0.02 times the wavelength 1550 nm. The anti-reflection film 25 of FIG. 4C has a film thickness of 1494 nm. Here, the thickness of each lamina corresponds to 0.03 times the wavelength 1550 nm. The anti-reflection film 25 of FIG. 4D has a film thickness of 2489 nm. Here, the thickness of each lamina corresponds to 0.1 times the wavelength 1550 nm. The anti-reflection film 25 of FIG. 4E has a film thickness of 9957 nm. Here, the thickness of each lamina corresponds to 0.2 times the wavelength 1550 nm.

In the first embodiment, the refractive index of each anti-reflection film 25 is expressed by a linear expression that increases linearly. What is essential here is that there occurs no abrupt change in refractive index at the interfaces 27 and 28 and that the anti-reflection film 25 has at least a predetermined film thickness.

For example, as shown in FIGS. 4A to 4C, in the cases where the anti-reflection films 25 having a thickness of less than 2000 nm, it is difficult to reduce the reflectance to −50 dB or lower entirely over the wavelength region of 1300 to 1700 nm, as apparent from the graphs of FIGS. 5A to 5D, whereas in the case where the anti-reflection films 25 having film thickness values of 2489 nm (ca. 2500 nm) and 9957 nm (ca. 10000 nm), as shown in FIGS. 4D and 4E respectively, the reflectance can be reduced to −50 dB or lower entirely over the wavelength region of 1300 to 1700 nm, as apparent from the graphs of FIGS. 5D and 5E.

Thus, when an anti-reflection film 25 having a refractive index distribution that is expressed by a linear expression, the thickness of the anti-reflection film 25 is preferably 2000 nm or more, and more preferably 10000 nm (10 μm) or more.

Preparation of Anti-reflection Film

Next, a process for preparing the anti-reflection film 25 having a refractive index distribution that is expressed by a linear expression will be described.

The anti-reflection film 25 is formed, for example, by subjecting target materials for forming the film having different refractive indices to simultaneous electrical discharge and controlling the discharge power outputs. For example, the following mixture films are formed by reactive sputtering using oxygen as a reactant gas as expressed by the following reaction scheme:

Si+Ti+O₂→SiₓTi_{y}O_{z}

Si+Al+O₂→SiₓAl_{y}O_{z}(mixture film of aluminum oxide)

where, SiₓTi_{y}O_{z} is a thin film comprising a mixture of silicon oxide and titanium oxide. SiₓAl_{y}O_{z} is a thin film comprising a mixture of silicon oxide and aluminum oxide.

The first embodiment can achieve the following advantages.

(1) Since the refractive indices of the anti-reflection film 25 at the interfaces 27 and 28 are substantially equal to the refractive index n1 of the optical fiber 23 and the refractive index n2 of the rod lens 22, respectively, index matching is achieved at each of the interfaces 27 and 28. Thus, reflection or loss is fully prevented from occurring at the interfaces 27 and 28.

(2) Since the refractive index distribution of the anti-reflection film 25 between the interfaces 27 and 28 is expressed by the linear expression, reflection can be fully reduced over a wide wavelength region. This makes it possible to use an anti-reflection film 25 at any wavelength in the wide wavelength region. For example, an optical fiber collimator 21 having an anti-reflection film 25 can reduce, in a dense wavelength-division multiplexing (DWDM) system, the reflectance to a low-level not only over the signal wavelength regions (1310 nm band, 1550 nm band) but also over the wavelength region of excitation light (980 nm) emitted from an erbium doped optical fiber amplifier.

(3) Since reflection at the interfaces 27 and 28 is suppressed, the light reflected at the interface 27 to return to the light source side is reduced. This dispenses with a back reflection preventing measure. For example, the diagonal polishing treatment of the end face of the rod lens 22 or that of the optical fiber 23 for preventing back reflection can be omitted. Thus, the process of producing optical fiber collimators 21 is simplified to lower the production cost.

(4) A desired gradient in the linear expression expressing the refractive index distribution can be obtained by suitably selecting the material of the laminas constituting the anti-reflection film 25 and the number of laminas. This increases the degree of freedom in designing the anti-reflection film 25.

(5) Since the anti-reflection film 25 has a film thickness of about 10000 nm (10 μm) or more, the loss (reflection) can be reduced to −50 dB or less entirely over the wavelength region of 1300 to 1700 nm.

A second embodiment and a third embodiment of the present invention will be described below. The same or similar elements as used in the first embodiment are affixed with the same reference numerals.

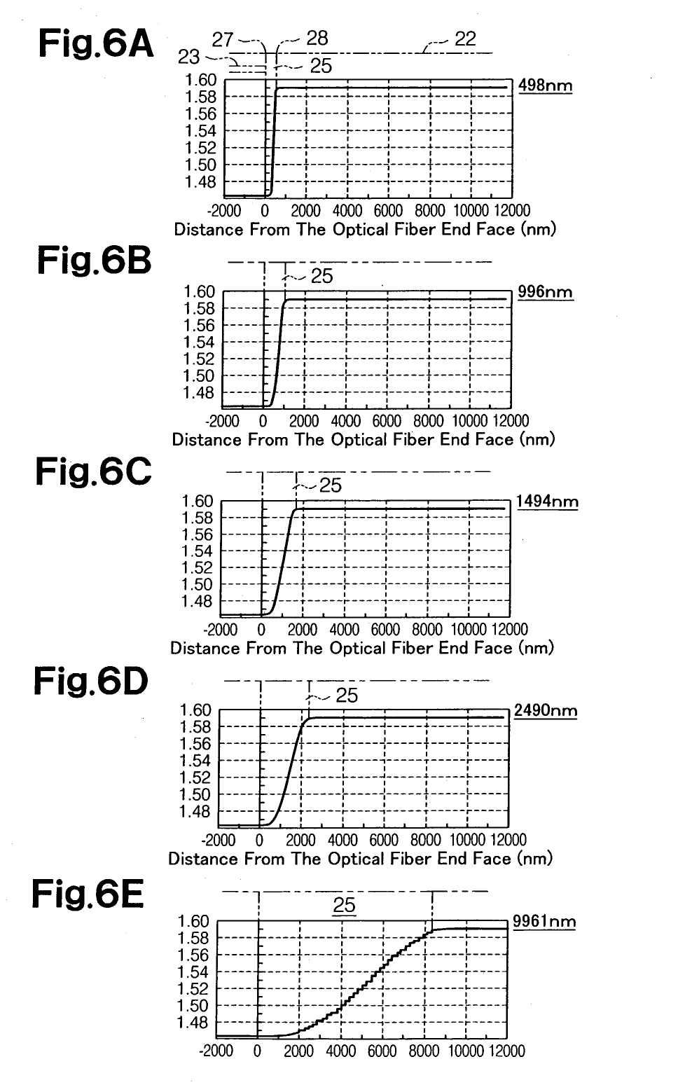

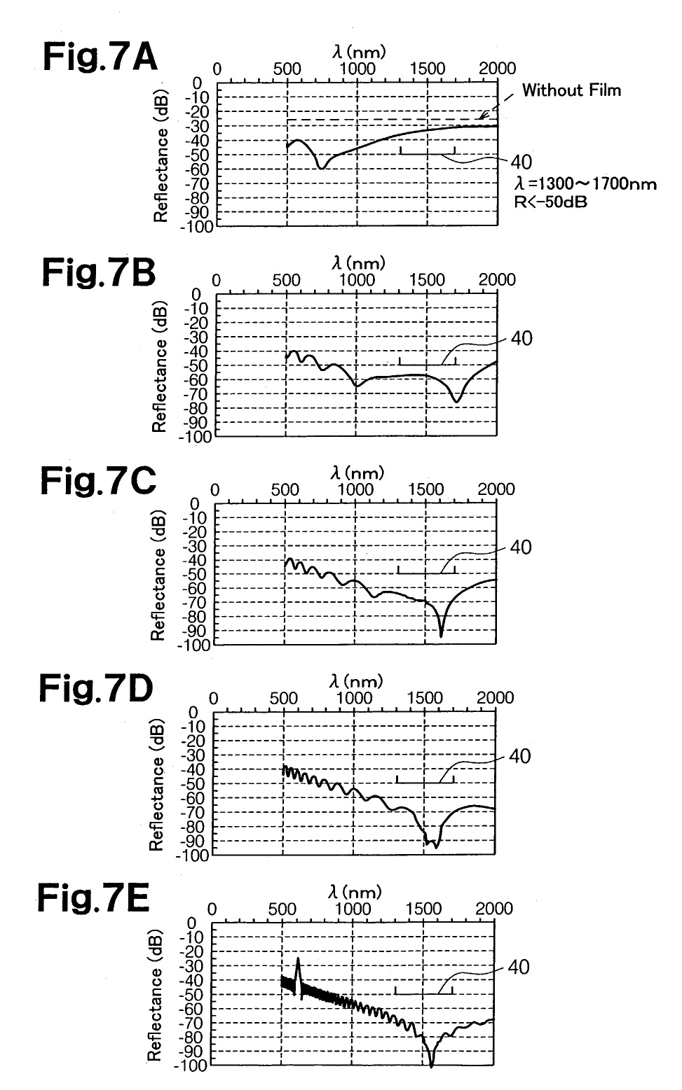

An optical fiber collimator 21 according to the second embodiment of the present invention will be described referring to FIGS. 6A to 6E and 7A to 7E. The optical fiber collimator 21 has an anti-reflection film 25 interposed between a rod lens 22 and an optical fiber 23. The anti-reflection film 25 has a refractive index that is expressed by a quintic which increases monotonously. The graphs in FIGS. 6A to 6E show refractive index distributions of anti-reflection films 25. The graphs in FIGS. 7A to 7E show reflection characteristics of the anti-reflection films 25 shown in FIGS. 6A to 6E, respectively.

The anti-reflection films 25 shown in 6A to 6E are each formed by laminating 49 layers of laminas. In the example shown in FIG. 6A, the anti-reflection film 25 has a film thickness of 498 nm. In the example shown in FIG. 6B, the anti-reflection film 25 has a film thickness of 996 nm. In the example shown in FIG. 6C, the anti-reflection film 25 has a film thickness of 1494 nm. In the example shown in FIG. 6D, the anti-reflection film 25 has a film thickness of 2490 nm. In the example shown in FIG. 6E, the anti-reflection film 25 has a film thickness of 9961 nm. The thickness of each lamina in the anti-reflection film 25 in FIGS. 6A to 6E correspond to 0.01, 0.02, 0.03, 0.05 and 0.2 times the wavelength 1550 nm, respectively.

The refractive index of the anti-reflection film in the second embodiment changes smoothly, and the index distribution is expressed by a quintic (polynomial equation of a higher order). It is essential that there is no refractive index gaps between at the interface 27 nor at the interface 28 and that the anti-reflection film 25 has at least a predetermined film thickness.

More specifically, as the example of FIG. 6A shows, in the case where the anti-reflection film 25 has a film thickness of about 500 nm, it is impossible to reduce the reflectance to −50 dB or lower entirely over the wavelength region of 1300 to 1700 nm, as apparent from the graph shown in FIG. 7A, failing to satisfy the standard in the field of optical communication. On the other hand, in the examples shown in FIGS. 6B to 6E, the anti-reflection films 25 having film thickness values of 10000 nm or more, the reflectance can be reduced to −50 dB or lower entirely over the wavelength region of 1300 to 1700 nm, as apparent from the graphs shown in FIGS. 7B to 7E.

As shown in FIG. 7E, in the case where the anti-reflection film 25 has a film thickness of about 10000 (10 μm) or more, an abnormal reflection can occur, for example, in a low band of around 600 nm. In addition, since it takes much time for forming an anti-reflection film 25 having such a relatively great thickness, it is preferred that the anti-reflection film 25 has a film thickness of less than about 10000 nm.

Therefore, in the second embodiment, the anti-reflection film 25 having a refractive index distribution that is expressed by a quintic is designed to have a film thickness in the range of about 1000 nm (1 μm) to about 10000 nm.

The second embodiment can achieve the following advantages.

(6) The anti-reflection film 25 has a refractive index distribution that is expressed by a quintic which increases monotonously. If derivatives of the quintic are set to be zero at the interfaces 27 and 28, gaps in refractive index are cleared off at the interfaces 27 and 28. Thus, reflection can be prevented from occurring at the interfaces 27 and 28.

(7) Since the anti-reflection film 25 has a refractive index distribution that is expressed by a quintic, changes in refractive index of the anti-reflection film 25 can be adjusted relatively freely. For example, occurrence of reflection can be prevented over a relatively wide wavelength region by designing the anti-reflection film 25 to have a refractive index distribution that is expressed by a quintic corresponding to a curve connecting smoothly the refractive index n1 of the optical fiber 23 to the refractive index n2 of the rod lens 22

(8) The anti-reflection film 25 has a film thickness of about 1 μm to about 10 μm. This can reduce the loss (reflection) to −50 dB or less entirely over the wavelength region of 1300 to 1700 nm, prevent abnormal reflection in the low wavelength band and reduce the time required for forming the anti-reflection film 25.

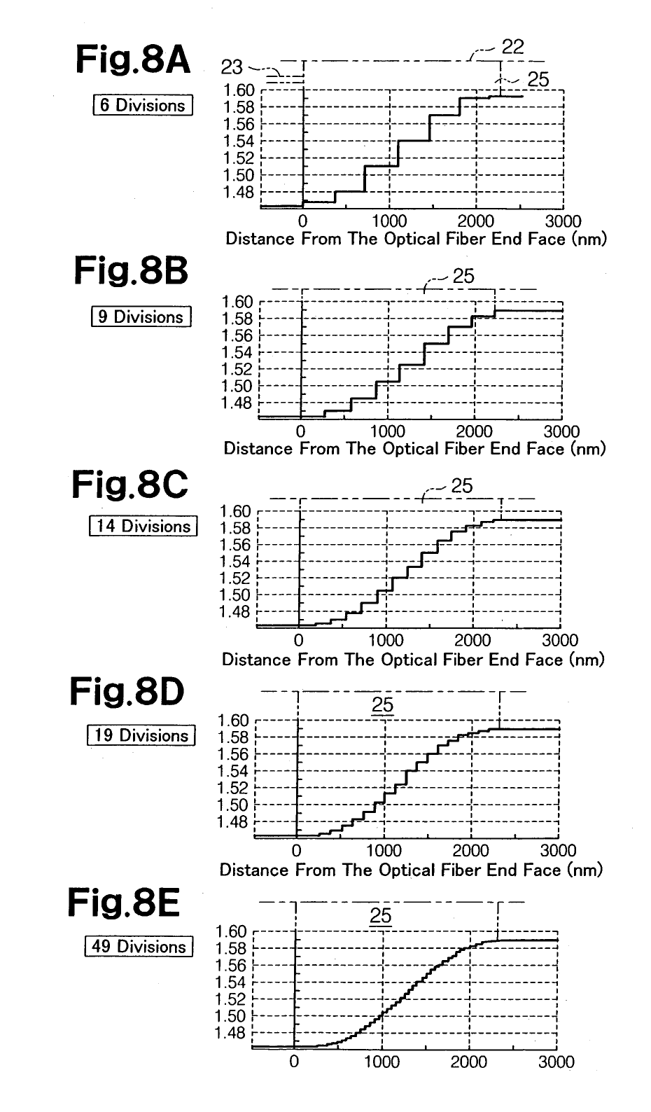

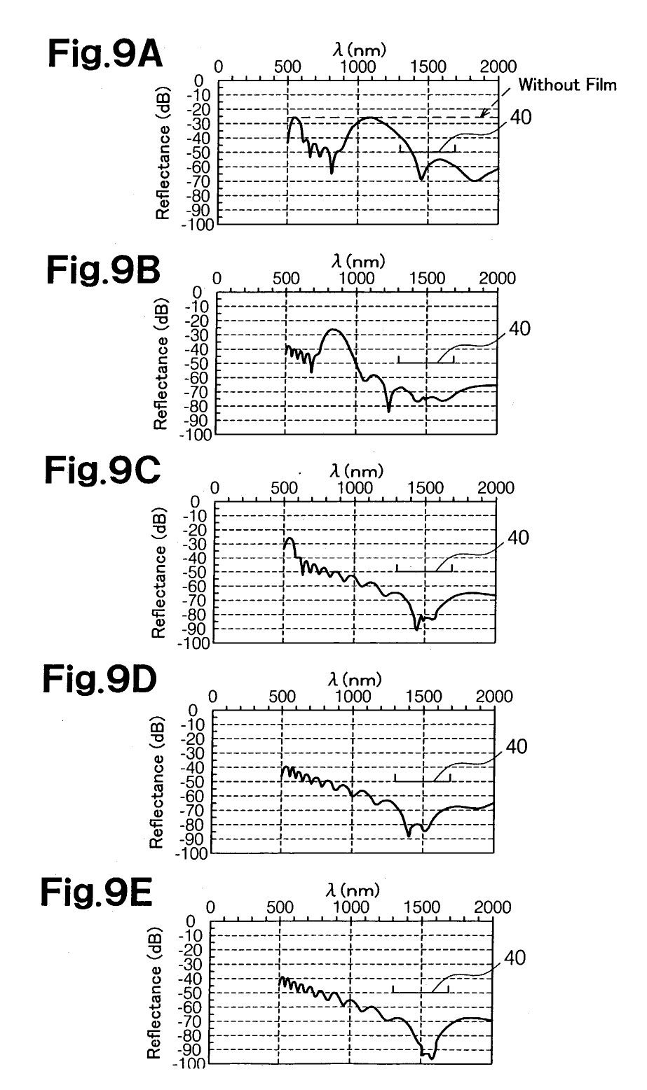

An optical fiber collimator 21 according to a third embodiment of the present invention will be described below referring to FIGS. 8A to 8E and 9A to 9E. The optical fiber collimator 21 of the third embodiment has an anti-reflection film 25 whose refractive index changes stepwise. FIGS. 8A to 8E show changes in refractive index along the optical axis of the anti-reflection film 25. FIGS. 9A to 9E show reflection characteristics of the anti-reflection films 25 shown in FIGS. 8A to 8E, respectively.

In each of the anti-reflection films 25 shown in FIGS. 8A to 8E, the refractive index thereof changes stepwise along the curve of the quintic. The anti-reflection film 25 has a film thickness of about 2 μm. In the anti-reflection film 25 shown in FIG. 8A, the refractive index changes stepwise in 6 stages (6 divisions). In the anti-reflection film 25 shown in FIG. 8B, the refractive index changes stepwise in 9 stages (9 divisions). In the anti-reflection film 25 shown in FIG. 8C, the refractive index changes stepwise in 14 stages (14 divisions). In the anti-reflection film 25 shown in FIG. 8D, the refractive index changes stepwise in 19 stages (19 divisions). In the anti-reflection film 25 shown in FIG. 8E, the refractive index changes stepwise in 49 stages (49 divisions).

In the case of the 6-division anti-reflection film 25 (FIG. 8A), the reflectance cannot be reduced to −50 dB or lower entirely over the wavelength region of 1300 to 1700 nm, as apparent from the graph shown in FIG. 9A. In the third embodiment, it is preferred that the anti-reflection film 25 has a stepped refractive index distribution such that the refractive index changes stepwise at least in 9 stages.

The third embodiment can achieve the following advantages.

(9) The refractive index of the anti-reflection film 25 changes stepwise in 9 stages in accordance with the quintic and has a film thickness of about 2 μm. Thus, loss (reflection) can be reduced to −50 dB or less entirely over the wavelength region of 1300 to 1700 nm, as shown in FIGS. 9B to 9E.

(10) When the refractive index of the anti-reflection film 25 changes stepwise in 14 stages or more, no great change occurs in reflection characteristics even if the number of stages is increased. In other words, in the case where the refractive index changes stepwise in 14 stages or more, there are obtained reflection characteristics comparable to that of the case where the refractive index changes almost continuously.

### EXAMPLE 1

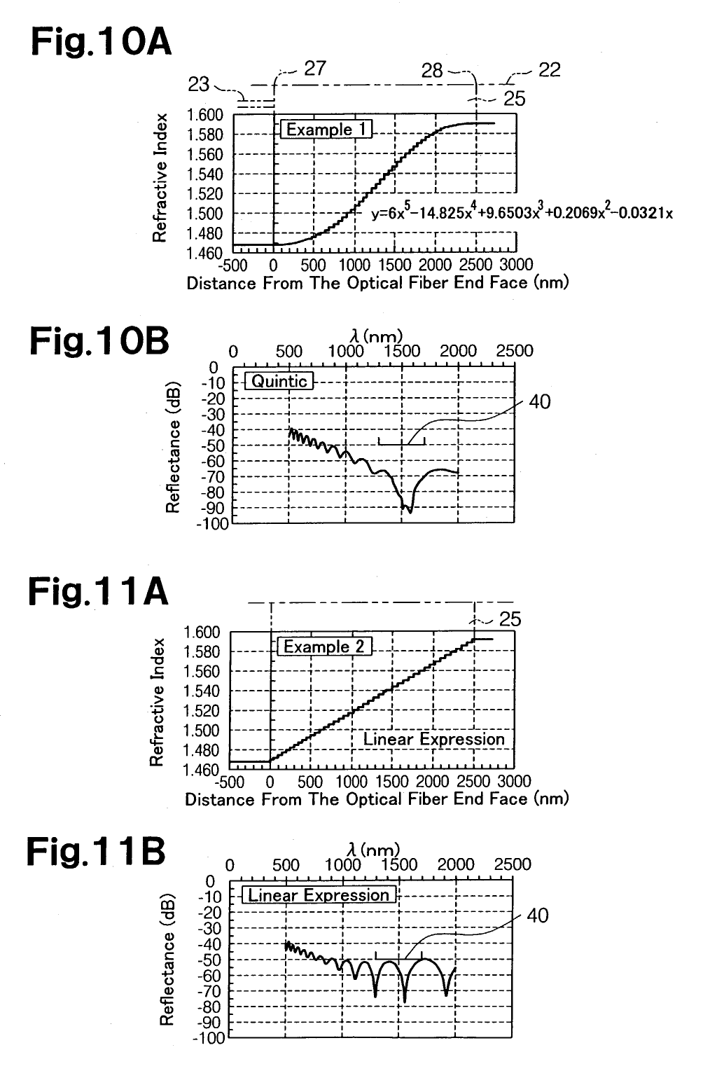

An optical fiber collimator 21 of Example 1 will be described referring to FIGS. 10A and 10B. The anti-reflection film 25 in the optical fiber collimator 21 of Example 1 has a refractive index distribution that is expressed by a quintic. FIG. 10A is a graph showing changes in refractive index of the anti-reflection film 25, and FIG. 10B is a graph showing characteristics of the anti-reflection film 25.

Formation of Anti-reflection Film

Formation of the anti-reflection film 25 of Example 1 was carried out in a chamber using a carousel type sputtering apparatus which performs simultaneous deposition from a pair of cathodes. A rod lens 22 was fixed to a carousel (a cylindrical holder) provided in the chamber. Aluminum (Al) and boron doped silicon (Si:B) were used as target materials. These two target materials were subjected simultaneously to electrical discharge using a mixed gas of oxygen and argon gas as a gas for the electrical discharge treatment and controlling the power supplies to the two cathodes separately. This reactive sputtering treatment formed a mixture film of aluminum oxide and silicon oxide on an end face of the rod lens 22. The revolution of the carousel, the oxygen gas flow rate, the argon gas flow rate and the gas pressure were 200 rpm, 100 sccm, 200 sccm, and 10 mTorr, respectively. The substrate was not heated during the film formation.

Power supplies to the cathodes were controlled so as to adjust the Al₂O₃ sputtering rate and the SiO₂ sputtering rate, respectively. Thus, the ratio of the Al₂O₃ component and the SiO₂ component in the mixture film was changed to adjust the refractive index thereof. A plurality of mixture films having different refractive indices were formed.

The following preliminary test was carried out beforehand. Under the film formation conditions as described above, single-layer mixture films were formed on Si substrates each mounted on the carousel by changing the value of power supply to each cathode. Refractive indices of the thus formed mixture films were measured using a spectral ellipsometer. Thus, the relationship between the power supply to each cathode and the refractive index of the mixture film was examined. Based on the relationship between the power supplies to each of the two cathodes and the refractive index of the mixture film thus formed, actual formation of the anti-reflection film was carried out.

According to the method as described above, an anti-reflection film 25 comprising 49 layers of laminas was formed on one end face of a rod lens 22, which has a center refractive index n of 1.590 (specification for optical communication system which carries out optical transmission at a wavelength band of 1550 nm using a single mode optical fiber) and which has polished parallel ends. The refractive index of the anti-reflection film 25 along the optical axis thereof changes in accordance with the following quintic (Equation 1), where y represents a refractive index and x represents the distance (nm) from the interface 27.

y=6x⁵−14.825x⁴+9.6503x³+0.2069x²−0.0321x (Formula 1)

FIG. 10A shows a refractive index distribution (λ is 1550 nm) of an anti-reflection film 25.

Connection of Anti-reflection Film and Optical Fiber

An anti-reflection film 25 was formed on an end face of a rod lens 22, and was connected to an optical fiber 23 in the following manner.

An ultraviolet curing optical adhesive having a refractive index substantially equal to that of the optical fiber 23 was applied onto the anti-reflection film 25. The optical fiber 23 was inserted to an optical fiber inserting hole defined in a glass capillary 26. The optical fiber inserting hole had a diameter substantially the same as that of the optical fiber 23. Then, an end face of the optical fiber 23 was polished (perpendicularly to the optical axis). The capillary 26 was bonded to the anti-reflection film 25, followed by ultraviolet irradiation to cure the optical adhesive, and thus the anti-reflection film 25 and the optical fiber 23 were bonded to each other. A single mode optical fiber code equipped with a connector was fused to the other end (entrance side) of the optical fiber 23 so that the optical fiber can be connected to a back reflection measuring device to be described below.

Measurement of Back Reflection

Back reflection was measured by connecting a 1.55 μm light source AQ-4137 or a 1.31 μm light source AQ-1326 (manufactured by Ando Electric Co., Ltd.) and the optical fiber 23 to a back reflection measuring device RM2050B (manufactured by JDS FITEL).

The uncoated end face (the end face opposite to the end formed with an anti-reflection film 25) of the rod lens 22 was subjected to diagonal optical polishing (ca. 8°) so as to reduce reflection at that end face to a negligible level. The intensity of the light reflected at the interface 27 between the anti-reflection film 25 and the optical fiber 23 was measured.

### EXAMPLE 2

An optical fiber collimator 21 of Example 2 will be described referring to FIGS. 11A and 11B. The optical fiber collimator 21 of Example 2 has an anti-reflection film 25 having a refractive index distribution that is expressed by a direct function. FIG. 11A is a graph showing changes in refractive index of the anti-reflection film 25, and FIG. 11B is a graph showing reflection characteristics of the anti-reflection film 25.

In Example 2, an anti-reflection film 25 was formed on an end face of a rod lens 22 in the same manner as in Example 1 by controlling the power supplies to two cathodes. The anti-reflection film 25 had properties as described below.

In the anti-reflection film 25 of Example 2, the refractive index changes in accordance with a linear expression in which the refractive indices at each of the surfaces of the film 25 conform to the refractive indices of the optical fiber 22 and the rod lens 22, respectively. FIG. 11A shows a refractive index distribution (where λ is 1550 nm) of the anti-reflection film 25. Measurement and the like were performed in the same manner as in Example 1.

### EXAMPLE 3

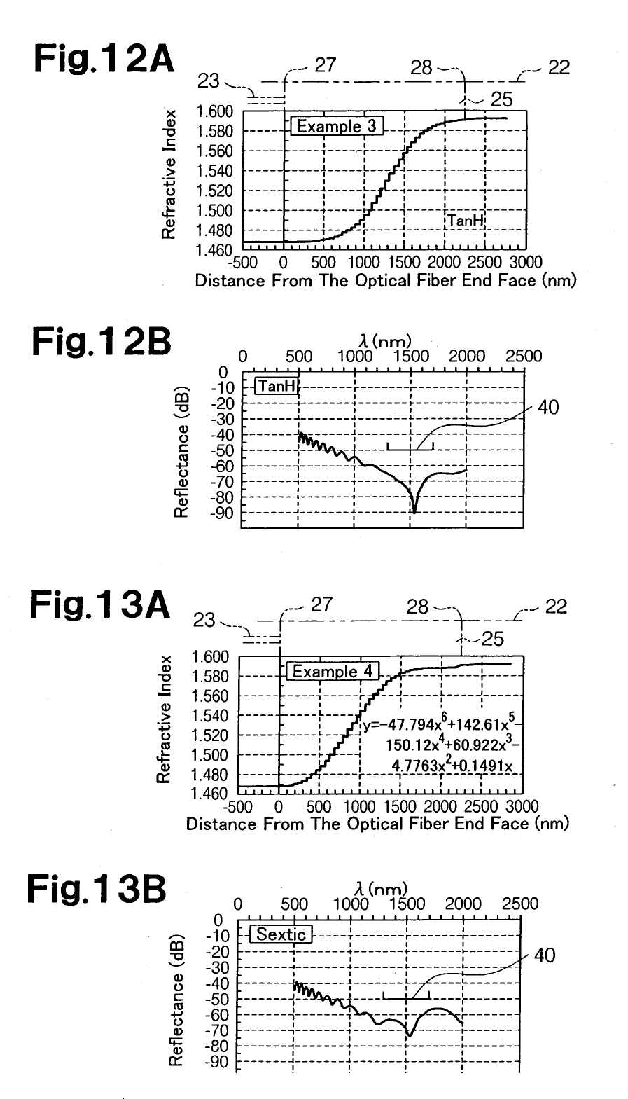

An optical fiber collimator 21 of Example 3 will be described referring to FIGS. 12A and 12B. The anti-reflection film 25 in the optical fiber collimator 21 of Example 3 has a refractive index distribution that is expressed by a hyperbolic function tan H (x). FIG. 12A is a graph showing changes in refractive index of the anti-reflection film 25, and FIG. 12B is a graph showing reflection characteristics of the anti-reflection film 25.

In Example 3, an anti-reflection film 25 was formed on an end face of a rod lens 22 by controlling the power supplies to two cathodes. The anti-reflection film 25 had properties to be described below.

In the anti-reflection film 25 of Example 3, the refractive index changes in accordance with tan H (x), and the refractive indices at each of the surfaces of the film 25 conform to the refractive indices of the optical fiber 23 and the rod lens 22, respectively. FIG. 12A shows a refractive index distribution (where λ is 1550 nm) of the anti-reflection film 25. Measurement and the like were performed in the same manner as in Example 1.

### EXAMPLE 4

An optical fiber collimator 21 of Example 4 will be described referring to FIGS. 13A and 13B. The anti-reflection film 25 in the optical fiber collimator 21 of Example 4 has a refractive index distribution that is expressed by a sextic which changes monotonously along the optical axis. FIG. 13A is a graph showing changes in refractive index of the anti-reflection film 25, and FIG. 13B is a graph showing reflection characteristics of the anti-reflection film 25.

In Example 4, also an anti-reflection film 25 was formed on an end face of a rod lens 22 by controlling the power supplies to two cathodes. The anti-reflection film 25 had properties to be described below.

In the anti-reflection film 25 of Example 4, the refractive index changes in accordance with the sextic (Equation 2), and the refractive indices at each of the surfaces of the film 25 conform to the refractive index of the optical fiber 23 and the rod lens 22, respectively. FIG. 13A shows a refractive index distribution (where λ is 1550 nm) of the anti-reflection film 25. Measurement and the like were performed in the same manner as in Example 1.

y=−47.794x⁶+142.61x⁵−150.12x⁴+60.922x³−4.7763x²+0.1491x (Equation 2)

### Comparative Example

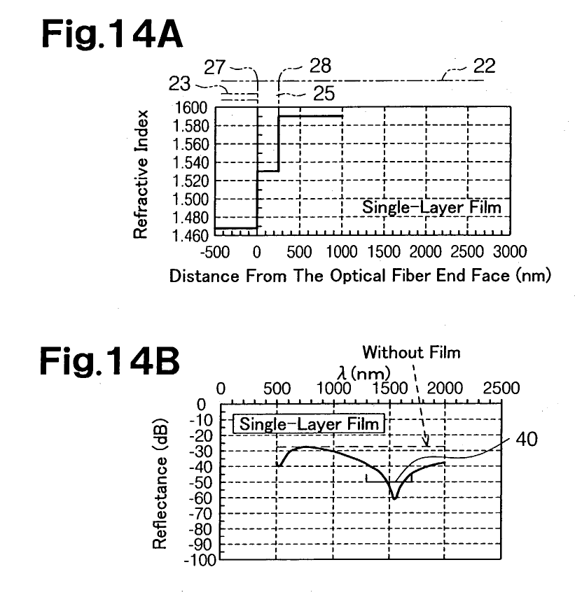

An optical fiber collimator of Comparative Example will be described referring to FIGS. 14A and 14B. In the optical fiber collimator of Comparative Example, a single-layer anti-reflection film was formed on an end face of a rod lens by controlling the power supplies to two cathodes. This single-layer film is a mixture film of Al₂O₃ and SiO₂. FIG. 14A shows refractive index distribution of the single-layer film along the optical axis thereof, and FIG. 14B shows reflection characteristics thereof.

Results

As shown in Table 1, in any of Examples 1 to 4, back reflection values were −50 dB or less in both the 1.55 μm band and the 1.31 μm band. Therefore, the optical fiber collimators of Examples 1 to 4 satisfy the requirements of reflectance in the field of optical communication. On the other hand, in Comparative Example, the back reflection in the 1.55 μm band was −50 dB or less, but that in the 1.31 μm band was −38.5 dB. Therefore, the optical fiber collimator of Comparative Example failed to satisfy the requirements of reflectance in the field of optical communication.

TABLE 1

back reflection

| | 1.55 μm band | 1.31 μm band |
|---|---|---|
| Exp. 1 | ≦ −70 dB | −67.4 dB |
| Exp. 2 | ≦ −70 dB | −67.8 dB |
| Exp. 3 | ≦ −70 dB | −65.3 dB |
| Exp. 4 | ≦ −70 dB | −64.4 dB |
| Comp. Exp. | ≦ −61.2 dB | −38.5 dB |

Example 3 shown in FIGS. 12A and 12B can achieve the following advantages.

(11) The anti-reflection film 25 has a refractive index distribution that is expressed by a function tan H such that the refractive index increases monotonously along the optical axis. Derived functions of the function tan H are set to be zero at the interfaces 27 and 28. Since the refractive index of the anti-reflection film 25 coincides at the interface 27 with that of the optical fiber 23 and at the interface 28 with that of the rod lens 22, reflection at the interfaces 27 and 28 can be reduced.

(12) The anti-reflection film 25 is formed in such a way as to have a refractive index distribution that is expressed by a function tan H. The anti-reflection film 25 can be designed to have a refractive index distribution that is expressed by a curve connecting smoothly the refractive index n1 of the optical fiber 23 to the refractive index n2 of the rod lens 22 by suitably setting the function tan H. Thus, reflectance can be reduced over a wider wavelength region.

(13) In the case where the anti-reflection film 25 has a film thickness of about 2000 nm, loss can be reduced to −50 dB or less entirely over the wavelength region of 1300 to 1700 nm. Further, the anti-reflection film 25 is formed in a relatively short time.

Table 2 shown below indicates, with respect to Examples 1 to 4 and Comparative Example, the difference between the refractive index of the layer (L1) of the anti-reflection film 25 to be brought into contact with the optical fiber 23 and the refractive index (1.4627 at 1550 nm) of the optical fiber 23, and the difference between the refractive index of the layer (Ln) of the anti-reflection film 25 to be brought into contact with the rod lens 22 and the center refractive index (1.5901 at 1550 nm) of the rod lens 22. In Examples 1 to 4 having achieved the reflectance of −50 dB or less, the differences in refractive index were all 0.01 or less. Meanwhile, the differences in refractive index in Comparative Example were greater than 0.01. Therefore, a reflectance of −50 dB or less can be achieved by forming an anti-reflection film having a difference in refractive index of 0.01 or less between the interfaces.

While the refractive index of the rod lens and that of the optical fiber have wavelength dispersions, changes in refractive indices in the wavelength region of 1300 to 1700 nm are about 0.1% in the case of the rod lens and about 0.03% in the case of the optical fiber. These changes are significantly smaller than the difference in refractive index 0.01, an anti-reflection has only to be formed as to have a difference in refractive index of 0.01 or less even if changes of wavelength is taken into consideration.

TABLE 2

| | difference in refractive index | | | | |
|---|---|---|---|---|---|
| | | | | | Comp. |
| | Exp. 1 | Exp. 2 | Exp. 3 | Exp. 4 | Exp. |
| Rod lens side | 0.0000 | 0.0025 | 0.0006 | 0.0002 | 0.0612 |
| Opt. fiber | 0.0055 | 0.0021 | 0.0057 | 0.0055 | 0.0663 |
| side | | | | | |

It should be apparent to those skilled in the art that the present invention may be embodied in many other specific forms without departing from the spirit or scope of the invention. Particularly, it should be understood that the present invention may be embodied in the following forms.

In the first embodiment, while the laminas constituting the anti-reflection film 25 are of a mixture of silicon oxide and aluminum oxide, the material of the laminas are not to be limited to it in the present invention. An optical film having a desired refractive index may be formed by means of reactive sputtering using a target material selected from Si, Ti, Zr, Al, Mg, Ge, Ta, Nb, Sn, Zn and Y. Meanwhile, it is also possible to use a mixture target material such as Al—Si, Al—Ge and Ti—Nbx. The mixture target material includes suboxide target materials and nitride target materials.

Both the quintic of Equation 1 and the sextic of Equation 2 are merely given as examples. The anti-reflection film 25 may be formed to have a refractive index distribution that is expressed by a polynomial equation other than Equations 1 and 2.

In each of the embodiments and Examples described above, the anti-reflection film 25 was formed by laminating a multiplicity of laminas having different refractive indices. However, the formation of the anti-reflection film 25 is not to be limited to the above method in the present invention. Effects that are similar to those described in the embodiments and Examples can also be obtained, even if interlayer counter diffusion occurred in the anti-reflection film 25 to allow the film 25 to have a continuous distribution in terms of the composition of the material.

As the optical device, there may be used other devices in place of the optical fiber collimator 21, so long as they are provided with a first optical element and a second optical element having refractive indices different from each other and they are of the structure in which light is introduced from the first optical element into the second optical element.

“The functions expressing a refractive index continuously changing between the two interfaces” include a function expressing a refractive index increasing or decreasing between the two interfaces.

The term “optical elements” includes rod lens, other types of lenses and prisms which are made of dielectric materials including quartz glass, other kinds of glass, resins, semiconductors and ferroelectric substances such as lithium niobate, liquid mediums such as liquid crystal, and gaseous mediums such as air. For example, the optical fiber 23 shown in FIG. 1 may be replaced with an optical element having a passage charged with liquid crystal or air.

The present examples and embodiments are to be considered as illustrative and not restrictive and the invention is not to be limited to the details given herein, but may be modified within the scope and equivalence of the appended claims.

What is claimed is:

1. An optical device including a first optical element having a first refractive index and a second optical element having a second refractive index which differs from the first refractive index, wherein light is introduced from the first optical element into the second optical element, the optical device comprising:
an anti-reflection film interposed between the first optical element and the second optical element, the anti-reflection film having a first interface opposing the first optical element and a second interface opposing the second optical element, the first interface having a refractive index substantially equal to that of the first refractive index, the second interface having a refractive index substantially equal to that of the second refractive index, wherein the refractive index of the anti-reflection film continuously changes between the first interface and the second interface.

2. The optical device according to claim 1, wherein the anti-reflection film has a refractive index distribution that changes monotonously from the first interface to the second interface and that is expressed by any of a polynomial equation of a higher order and a function tan H.

3. The optical device according to claim 1, wherein the derivatives of the function expressing the refractive index distribution which are zero at the first and second interfaces.

4. The optical device according to claim 1, wherein the anti-reflection film has a thickness of about 1 μm to about 10 μm.

5. The optical device according to claim 1, wherein the difference between the refractive index of the anti-reflection film at the first interface and the first refractive index is 0.01 or less, and the difference between the refractive index of the anti-reflection film at the second interface and the second refractive index is 0.01 or less.

6. The optical device according to claim 1, wherein the first optical element is a gradient index type rod lens having the anti-reflection film formed on one end face thereof, and the second optical element is a single mode optical fiber having a polished end face, the anti-reflection film being bonded to the polished end face.

7. An optical device including a first optical element having a first refractive index and a second optical element having a second refractive index which differs from the first refractive index, in which light is introduced from the first optical element into the second optical element, the optical device comprising:
an anti-reflection film interposed between the first optical element and the second optical element, the anti-reflection film having a plurality of laminas including a first lamina opposing the first optical element and a second lamina opposing the second optical element, wherein the first lamina has a refractive index substantially equal to that of the first refractive index, the second lamina has a refractive index substantially equal to that of the second refractive index, and wherein the refractive index of the anti-reflection film changes monotonously between the first lamina and the second lamina.

8. The optical device according to claim 7, wherein the anti-reflection film has a refractive index distribution that changes monotonously from the first lamina to the second lamina and that is expressed by any of a polynomial equation of a higher order and a function tan H.

9. The optical device according to claim 7, wherein the derivatives of the function are zero at an interface between the first optical element and the first lamina and at an interface between the second optical element and the second lamina.

10. The optical device according to claim 7, wherein the anti-reflection film has a thickness of about 1 μm to about 10 μm.

11. The optical device according to claim 7, wherein the refractive index of the anti-reflection film changes at a rate which is smaller as it approaches the first optical element and the second optical element.

12. The optical device according to claim 7, wherein the difference between the refractive index of the first lamina and the first refractive index is 0.01 or less, and the difference between the refractive index of the second lamina and the second refractive index is 0.01 or less.

13. The optical device according to claim 7, wherein at least one of the first optical element and the second optical element is formed of a material selected from the group consisting of glass, resins, semiconductors and dielectric materials.

14. The optical device according to claim 7, wherein at least one of the first optical element and the second optical element is a lens.

15. The optical device according to claim 7, wherein at least one of the first optical element and the second optical element is an optical fiber.

16. The optical device according to claim 7, wherein the first optical element is a gradient index type rod lens, and the second optical element is an optical fiber.

17. The optical device according to claim 7, wherein at least one of the first optical element and the second optical element is a planer optical waveguide.

18. The optical device according to claim 7, wherein at least one of the first optical element and the second optical element has a passage charged with a liquid or a gas.

19. An optical device comprising:
an optical fiber having a first refractive index;
a rod lens, which is optically bonded to the optical fiber and has a second refractive index; and
an anti-reflection film including a first lamina formed contiguous to the optical fiber and having a refractive index substantially equal to the first refractive index, a second lamina formed contiguous to the end face of the rod lens and having a refractive index substantially equal to the second refractive index, and a plurality of third laminas laminated between the first lamina and the second lamina and having a refractive index which differ from the first and second refractive indices.

20. The optical device according to claim 19, wherein the difference between the refractive index of the first lamina and the first refractive index is 0.01 or less, and the difference between the refractive index of the second lamina and the second refractive index is 0.01 or less.

21. The optical device according to claim 20, wherein the difference between refractive indices of every two adjacent third laminas is constant.

22. The optical device according to claim 21, wherein the anti-reflection film has a thickness of greater than 2000 nm.

23. The optical device according to claim 20, wherein the difference between refractive indices of every two adjacent third laminas reduces toward the first and second laminas.

24. The optical device according to claim 23, wherein the anti-reflection film has a thickness of about 1 μm to about 10 μm.

25. The optical device according to claim 19, having a reflectance of −50 dB or less in a wavelength region of 1300 to 1700 nm.

26. The optical device according to claim 19, wherein each lamina is an optical mixture film formed by means of reactive sputtering using a plurality of target materials.
